(19) United States
(12) Patent Application Publication
(10) Pub. No.: US 2009/0171530 A1
(43) Pub. Date: Jul. 2, 2009

(54) Aerodynamic control of a three-wheel vehicle

(76) Inventor: Samuel Hall Bousfield, Meadow Vista, CA (US)

Correspondence Address: Samuel Hall Bousfield, 1820 Hillish Rock Road, Meadow Vista, CA, 95722, US

(21) Appl. No.: 12/005,601

(22) Filed: Dec. 28, 2007

(51) Int. Cl. B60G 17/018

(52) U.S. Cl. 701/37; 280/124.103

(57) ABSTRACT

This invention relates generally to an aerodynamic means to stabilize and tilt a three-wheel vehicle for cornering that is speed dependant and automatic in operation. Having a wing with movable control surfaces enables use of the wing to provide a tilting force utilized in cornering. If also connected by any of several means to the suspension system, the present invention also provides a vertically stabilizing force to counteract the pitching forces found in land vehicles due to surface irregularities encountered by the tires or wheels.

### CROSS REFERENCE TO RELATED APPLICATIONS

N/A

### STATEMENT REGARDING FEDERALLY SPONSORED RESEARCH AND DEVELOPMENT

No State or Federal funds were used for the research and development of this invention.

### REFERENCE TO SEQUENCE LISTING, A TABLE, OR A COMPUTER PROGRAM LISTING COMPACT DISC APPENDIX

N/A

### BACKGROUND OF THE INVENTION

Three-wheeled vehicles provide the minimum number of wheels required for a stable vehicle at rest and in motion. Two-wheeled vehicles can be designed to provide stability during motion, but not at rest—at least, not unattended. While a potentially lighter structure can be designed using three wheels rather than four, cornering of a three-wheel vehicle has numerous disadvantages over a four-wheel vehicle, chiefly under-steer or over-steer, depending upon whether the third wheel is in the front or rear of the vehicle.

It is not absolutely required to provide leaning for a three-wheel vehicle. A vehicle with a low center of gravity will perform adequately in many cases, regardless of the location of the third wheel. Leaning, however, will usually increase the turning capability of any vehicle, and adds a motorcycle-like feel to the ride, which may be preferable for enhanced ride enjoyment.

Most leaning devices for three-wheel vehicles involve mechanical leaning of some type. There are several designs that provide leaning as directed by the driver, and many that are automatic in nature. One such automatic type is shown in U.S. Pat. No. 5,765,846 by Dieter Braun. In this disclosure, a means is described that mechanically and automatically leans a vehicle into the turn. The vehicle in this case is a three-wheel vehicle with two-wheels in front and a single rear wheel. The two wheels are provided with the means to remain horizontal to the pavement while the body and rear wheel is leaned as a unit.

Another leaning device is found on the Mercedes-Benz LifeJet concept, which uses mechanical tilting control managed by a computer and multiple sensors that detect road speed, lateral movement, and suspension status to tilt the vehicle via the two front wheels up to thirty degrees. While excellent performance can be had with this system, it is technically complicated, expensive, and with many different parts that could fail.

A simpler design is Tilting Motorworks motorcycle conversions, which substitute two tilting wheels for the front wheel of a motorcycle. Tilting Motorworks utilizes the principle of manually leaning, rather than mechanically induced leaning technology. Manually leaning has the benefit of allowing a larger lean angle, and giving the rider the opportunity and responsibility for inducing the lean. While this does give the possibility of a leaning three-wheeler, there is a lag time involved with manually leaning, as one first has to counter-steer by steering slightly away from the turn in order to initiate the lean, as is done typically in a two-wheel motorcycle.

Carver produces a three wheel tilting vehicle that has active mechanical tilting via a torque actuator driven by a multi-stage manifold that provides hydraulic leaning responsive to speed as well as turning inputs from the steering wheel. This system produces leaning without the counter-steer effort of the Tilting Motorworks design. Similar to Mercedes, the weakness is a complicated system featuring many dependant parts.

General Motors produced the Lean Machine, which kept the rear two wheels flat on the ground by rotating the main body of the vehicle, which also housed the single front wheel. This method included pedals operated by the driver to keep the vehicle leaned or upright, depending on need. It was deemed difficult to drive due to the added complexity of operating the pedals for leaning. Project 32 Slalom combined both a computerized, automatic leaning technology with a manually controlled leaning feature in its three-wheeler.

The idea of all of these vehicles is to produce the excitement, enhanced performance, and comfort of leaning as one finds in a two-wheel motorcycle, and incorporate this into a three-wheel vehicle. The present invention aims to provide these same abilities in a simpler and more efficient manner.

### BRIEF SUMMARY OF THE INVENTION

The present invention provides a means to lean a three-wheel vehicle into a turn that is responsive to speed and driver input. A forward wing or spoiler is mounted at the front of the vehicle, with aircraft-like control surfaces on two sides connected to the steering wheel. Turning the steering wheel moves the control surfaces in an opposing fashion, producing an immediate roll along the longitudinal axis of the vehicle. By utilizing aerodynamic forces from the forward wing, leaning is achieved on a gradient scale depending on speed—as the airspeed increases past the wing, its force grows. As the vehicle speed, and hence airspeed past the wing, decreases, the force lessens.

Through a simple adjustable progressive linkage, initial actuation of the tilting mechanism can be fine tuned to provide a mechanical lean at the outset of driver input for an aircraft-like bank and turn. There are very few moving parts to break, and the mechanism is fairly inexpensive and lightweight, especially compared to many of the computer-controlled active systems presently found.

Quite in addition, connection of the control surfaces to the front wheel provides an upward or downward force to counteract bumpiness in a roadway, and even out the ride using aerodynamic forces.

### BRIEF DESCRIPTION OF THE DRAWINGS

FIG. 1 shows a four-view of the preferred embodiment.

FIG. 2 shows a front view of the preferred embodiment at rest with control surfaces at full twist.

FIG. 3 shows a front view of the preferred embodiment showing the physical forces at work in the direction of a turn.

FIG. 4 shows a front view of the preferred embodiment showing the physical forces at work in the direction of a turn.

FIG. 5 shows an isometric drawing of the forces at work.

FIG. 6 shows an enlarged cut-away view of the preferred embodiment to show the linkage assembly involved.

### DETAILED DESCRIPTION OF THE INVENTION

Reference will now be made in detail to the preferred embodiment of the invention, which is illustrated in the accompanying drawings. While the invention will be described in conjunction with the preferred embodiment, it will be understood that it is not intended to limit the invention to this embodiment. On the contrary, the invention is intended to cover alternatives, modifications and equivalents, which may be included within the spirit and scope of the invention as defined by the appended claims. As an example, although mechanical connections are shown below, electrical or hydraulic actuation of the moving parts of the device are also possible.

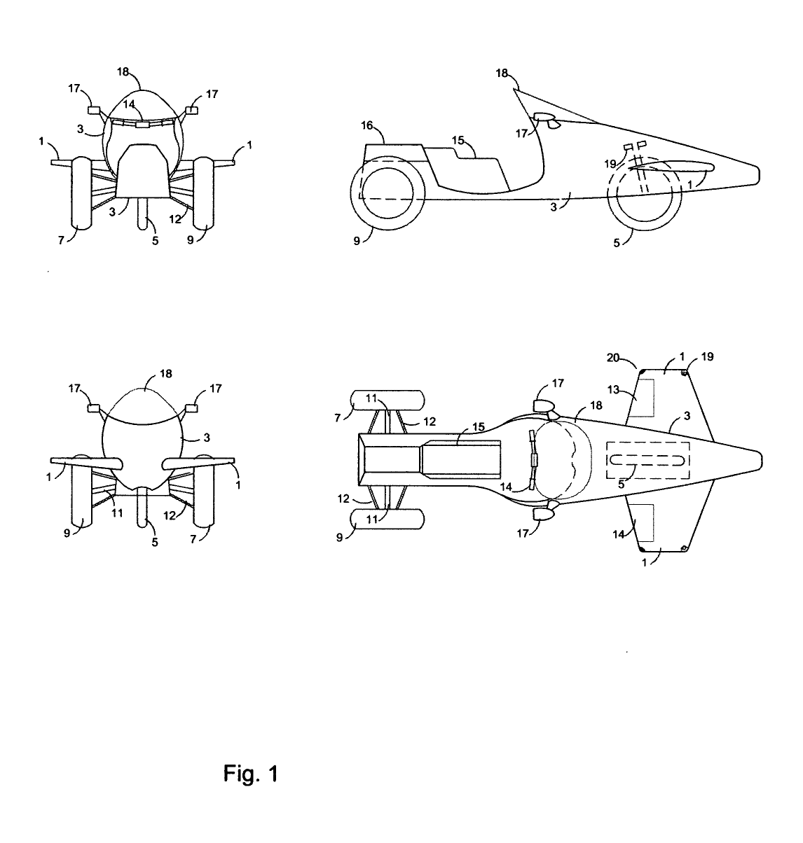

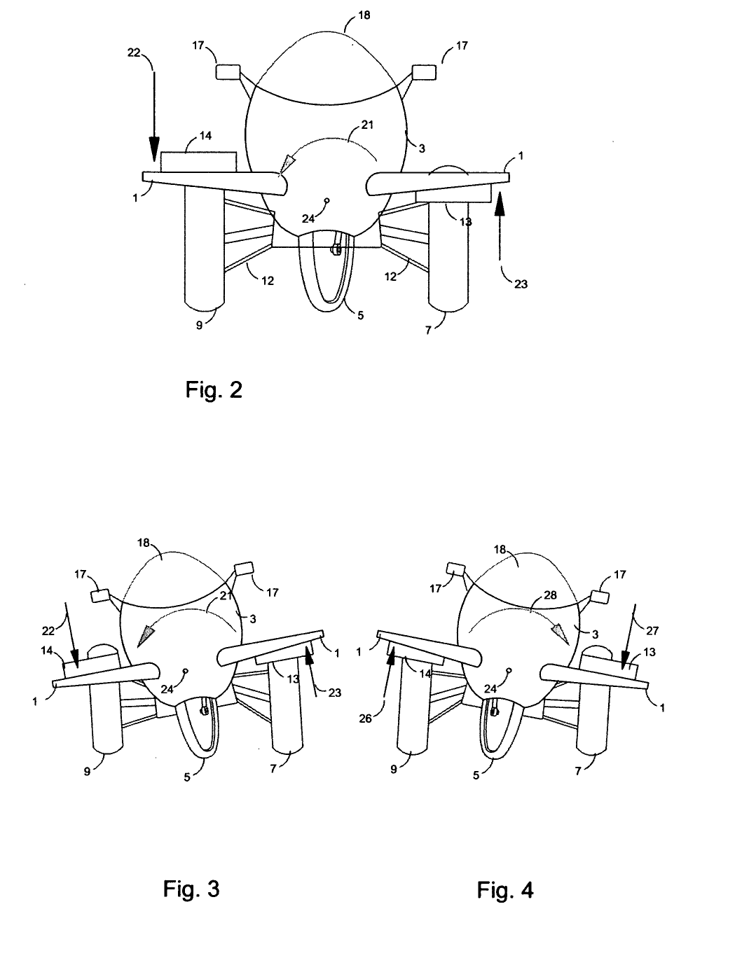

The present invention, in a general sense, is shown FIG. 1 & FIG. 2. FIG. 1 is an overview of the preferred embodiment. While a three-wheel vehicle with one wheel in front is shown, a vehicle with two wheels in front would also be possible with the present invention. The view shows a front mounted wing (1) attached to a vehicle body (3), which houses a front wheel (5), with the said body also supported on two rear wheels (7, 9). Motive sources for the vehicle are not relevant to the present invention, and are not elaborately shown, as any motive means will suffice, although drive shaft (11) and double ‘A’ frame suspension (12) is shown to indicate one method of rear-wheel drive and suspension. At the trailing edge of said wing, control surface (13) is mounted and connected via means common in the aerodynamic art to handlebar (14). Said handlebar is also connected to said front wheel, which is supported by a motorcycle-like triple-clamp (19).

A seat (15) is attached to said body, ahead of motor housing (16). Also shown are rear view mirrors (17), windshield (18), front turn signals (19), and rear turn signals (20).

FIG. 2 shows a front view of the preferred embodiment at rest with control surfaces activated by turning the steering wheel. To orient the viewer in this view, we have wings (1) attached to a vehicle body (3), which is connected to rear wheels (7 & 9) via suspension system—in this case double ‘A’ arms (12). Also supporting the said vehicle body is front wheel (5). Required of a three-wheel vehicle, though not required for the present invention, are rear view mirrors (17). A windshield (18) is also shown.

The handlebar or steering wheel, being connected to the said front wheel by means common to the art, has turned the said front wheel to the right as viewed by the driver. Control surfaces (13, 14) are connected to the handlebars via said front wheel in a manner described in a later figure. The movement of the front wheel to one side produces movement in the control surfaces (13, 14), one up and one down. This produces no force upon the wings at rest, but as forward motion is engaged, the action of airflow over the said wing and said control surfaces would produce a pair of forces (22, 23) that in turn would produce a rolling moment (21) about the longitudinal axis of the vehicle (24)—in this view seen as a point. The forces (22, 23) start out at zero with the vehicle at rest, and increase proportionally with an increase in forward vehicle speed. With further movement of the steering wheel, more control surface movement is produced, also producing more rolling moment in conjunction with more front wheel movement.

All of this relates to a coordinated lean and turn combination that can be sized to produce a leaning force for any size vehicle by altering the size and shape of wing and control surface as may be commonly found in the aerodynamic arts. Although shown at the front of the vehicle, the wing may be placed at any point along the vehicle body, and altered placement may be required for best vehicle handling characteristics depending on the weight and balance of the vehicle itself, as well as vehicle stiffness.

A different view of the physics of the tilting mechanism is shown in FIGS. 3 & 4, which are front views of the preferred embodiment showing the physical forces at work in both directions of turn. In FIG. 3 is shown a front wing (1) attached to a vehicle body (3) that is supported by front wheel (5) and two rear wheels (7, 9). Control surfaces (13, 14) in said wing are being acted upon by the steering mechanism as described above, causing a one-up, one-down attitude of said control surfaces with the front wheel set for a right turn as viewed by the driver. Said control surfaces produce forces (22, 23) on said wing, which transfers said forces into a rolling moment (21) around the longitudinal axis (24) of said vehicle—in this view, seen as a point. Said rolling moment produces a vehicle lean, compressing the suspension of the rear wheel (7), while unloading the suspension of the other rear wheel (9), to help produce a right turn as seen by the driver.

At the sake of seeming redundant, in FIG. 4 is shown a front wing (1) attached to a vehicle body (3) that is supported by front wheel (5) and two rear wheels (7, 9). Control surfaces (13, 14) in said wing are being acted upon by the steering mechanism as described above, causing a one-up, one-down attitude of said control surfaces with the front wheel set for a left turn as viewed by the driver. Said control surfaces produce forces (26, 27) on said wing, which transfers said forces into a rolling moment (28) around the longitudinal axis (24) of said vehicle—again in this view, seen as a point. Said rolling moment produces a vehicle lean, compressing the suspension of the rear wheel (9), while unloading the suspension of the other rear wheel (7) to help produce a left turn as seen by the driver.

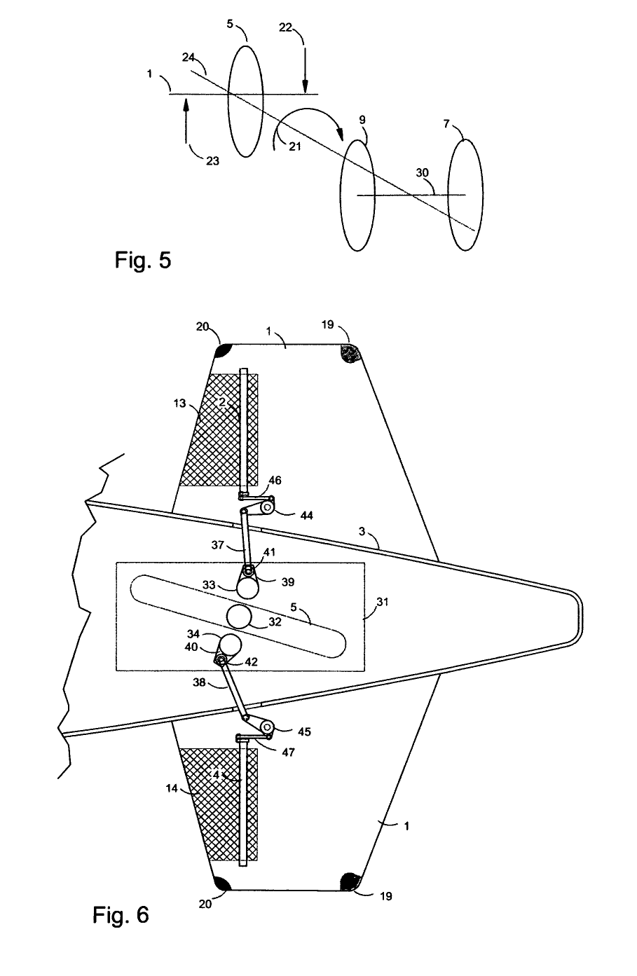

The front wing can also be utilized to produce an overall slight down-force on the front wheel for improved tire grip and stability. There is the potential of an overall downward force acting upon said wing given a slight downward orientation of the wing relative to the ground plane. A neutral orientation may also be acceptable, but an upward orientation is not advisable due to the potential to lift the front wheel off the ground at high speeds. FIG. 5 is an isometric sketch that shows the physics of the forces at work during a turn. In this view, a line indicating the plane of the wing (1) is shown being acted upon by two forces (22, 23) that impart a rolling moment (21) along the longitudinal axis (24) of the vehicle. Front wheel (5), and rear wheels (7, 9) are shown in their relative positions, as well as a rear wheel axis (30). Not shown is the resultant effect of the rolling moment upon the vehicle and wheels, this being a rudimentary force diagram only.

FIG. 6 is a cut-away view of the preferred embodiment to show one means to operate the control surfaces. Here we find the front wheel (5), viewed from above, in a right turn. Around the wheel is a wheel well (31) in the vehicle body (3). Above the said wheel would be found the center bearing (32) of a triple-clamp, as well as two front suspension forks (33, 34) as is commonly found in the motorcycle art. As commonly known, motorcycle front suspension is accomplished generally by having the front forks rotate about the center bearing, which is fixed to the motorcycle frame. Steering handlebars or steering means are attached via the triple-clamp assembly that rigidly holds the main bearing and front forks in relation to one another, while allowing rotation about the center bearing. In this view are seen push rods (37, 38) connected on one end to a front fork (33, 34) with a rigid mount (39, 40) having a ball joint (41, 42) or other rotation device. The other end of said push rods are connected to a rocker arm (44, 45) pivotally mounted to the wing (1). A shorter push rod (46, 47) is connected to the control surfaces (13, 14) via pivot rod (2, 4) slightly off center of the pivot rod, using rotational bearings to allow movement. The said shorter push rods are also connected to the side of said rocker arm again using rotational bearings allowing movement at the joint.

As the wheel has been turned to the right, push rod (37) causes rotation of rocker arm (44) in a clockwise fashion, which pulls shorter push rod (46) away from control surface (13). As push rod (46) is mounted off-axis from, and slightly above, the center of pivot rod (2), the movement of push rod (46) toward the vehicle front will produce a rotating moment about said pivot rod. The attached control surface (13) is thereby rotated upward relative to the vehicle body (3).

In a similar fashion in this turning of the wheel to the right, push rod (38) causes rotation of rocker arm (45) in a clockwise fashion, which pushes shorter push rod (47) toward the rear of the vehicle. As push rod (47) is mounted off-axis from, and slightly above, the center of pivot rod (4), the rearward movement of push rod (47) will produce a rotating moment about said pivot rod. The attached control surface (14) is thereby rotated downward relative to the vehicle body (3). It can be seen that movement of said steering handlebars affect both the front wheel and the control surfaces simultaneously. For reference, also shown in this view is forward turn signals (19) and rear turn signals (20).

A further potential can be shown by FIG. 6, and bears further description. If the rigid mounts (39, 40) are fastened to the top of an inverted fork front suspension (forks that move upwards or downwards with the front wheel), push rods (37, 38) would have another axis of rotation and movement which parallels the front forks and is determined by the movement of the front wheel (5). As the said front wheel moves upward, as if a bump were encountered, the rigid mounts (39, 40) are both forced upward. Quite separate from the left or right turn input from the wheel, the control surfaces (13, 14) would be forced to move upwards. As can be seen, a combination effect upon the control surfaces is then produced, with the turning of the front wheel producing an opposite rotation of the pair of control surfaces (one up and one down), and the movement up and down of the said front wheel producing an upward or downward rotation of both control surfaces together. This control mechanism could produce both a tilting moment in a turn, and an upward or downward force to counter-act the pitching one would normally encounter traveling a bumpy or uneven surfaced roadway.

Encountering a bump in the road pushes the wheel and control surfaces upward. The control surfaces produce a force downward as a result of their position relative to the wing, which counteracts the normal response of the vehicle body wanting to pitch upward to absorb the shock of the bump. The front wheel dropping into a dip or hole would produce the opposite effect, and act to even out the ride. This effect is possible with or without using the control surfaces to produce leaning. The effect is most applicable to vehicles of lower weight that do not have sufficient mass in the vehicle to counteract the pitching forces acting upon it.

What is claimed as the present invention is:

1. A land vehicle having an aerodynamic wing on each side of the vehicle, with said wings having a control surface mounted on each wing, said control surfaces operating opposite to each other so that when one control surface is raised the other is lowered, said control surfaces able to produce a rolling moment about the longitudinal axis of said vehicle while vehicle is in motion.

2. As in claim 1, where said control surfaces are connected to a steering device for said vehicle such that when steering input for a turn is introduced, said control surfaces act, in cooperation with said wings, to produce a rolling moment about the longitudinal axis of said vehicle so as to lean the vehicle into the turn.

3. A land vehicle having an aerodynamic wing on each side of the vehicle, with said wings having a control surface mounted on each wing, said control surfaces connected to a suspension device such that when the suspension is deflected upward, both control surfaces are deflected upward, and conversely, when the suspension is deflected downward, both control surfaces are deflected downward.

4. As in claim 1, where said control surfaces are also connected to a suspension device such that when the suspension is deflected upward, both control surfaces are deflected upward, and conversely, when the suspension is deflected downward, both control surfaces are deflected downward.

5. As in claim 1 where said control surfaces are connected to one or more electric actuators, said actuators directed by a computer for said vehicle such that when steering input for a turn is introduced, said control surfaces act, in cooperation with said wings, to produce a rolling moment about the longitudinal axis of said vehicle so as to lean the vehicle into the turn.

6. As in claim 1 where said control surfaces are connected to one or more hydraulic actuators, said actuators connected to a master pump which is connected to a steering device for said vehicle such that when steering input for a turn is introduced, said control surfaces act, in cooperation with said wings, to produce a rolling moment about the longitudinal axis of said vehicle so as to lean the vehicle into the turn.

7. As in claim 1 where said control surfaces are connected to one or more electric actuators, said actuators connected to a steering device sensor for said vehicle such that when steering input for a turn is introduced, said control surfaces act, in cooperation with said wings, to produce a rolling moment about the longitudinal axis of said vehicle so as to lean the vehicle into the turn.

8. As in claim 1 where said control surfaces are connected to one or more electric actuators, said actuators directed by a computer for said vehicle, said computer having steering sensor, roll sensor, speed sensor, and suspension sensor, such that when steering input for a turn is introduced, said control surfaces act, in cooperation with said wings, to produce a rolling moment about the longitudinal axis of said vehicle so as to lean the vehicle into the turn, and additionally, when ground irregularities are encountered, said control surfaces act to stabilize the vehicle in a suspension capacity.
